(19) United States
(12) Patent Application Publication
(10) Pub. No.: US 2017/0165785 A1
(43) Pub. Date: Jun. 15, 2017

(54) CONNECTION UNIT FOR COMPOSITES

(71) Applicant: Hyundai Motor Company, Seoul (KR)

(72) Inventors: Dong Keun Yoo, Ansan (KR); Chang Dong Kim, Suwon (KR); Min Soo Kim, Suwon (KR)

(21) Appl. No.: 15/098,928

(22) Filed: Apr. 14, 2016

(30) Foreign Application Priority Data
Dec. 10, 2015 (KR) 10-2015-0176390

(51) Int. Cl. B23K 11/11; F16B 11/00

(52) U.S. Cl. CPC B23K 11/115; F16B 11/006

(57) ABSTRACT

A connection unit for composites is provided to connect upper and lower plates that overlap each other. The connection unit includes a first connector having a central first downwardly-protruding portion configured to be inserted into an aperture in the upper plate and a peripheral first flange portion, a welding recess being formed in the first protruding portion. Additionally, a second connector has a central second upwardly-protruding portion configured to be inserted into an aperture in the lower plate and a peripheral second flange portion, a welding recess being formed in the second protruding portion. The first and second protruding portions are in contact with each other when inserted into the upper and lower plates, and the contact ends of the first and second protruding portions are welded to each other to secure the upper and lower plates to each other.

### CROSS-REFERENCE TO RELATED APPLICATION

This application claims the priority benefit of Korean Patent Application No. 10-2015-0176390, filed on Dec. 10, 2015 in the Korean Intellectual Property Office, the disclosure of which is incorporated herein by reference.

### BACKGROUND

1. Field of the Invention

The present invention relates to a connection unit for composites, which enables an upper plate and a lower plate, formed of composites, to be connected by welding.

2. Description of the Related Art

When a vehicle body is formed of composites including, e.g. carbon fibers, there is the necessity to bond the composites to each other. In particular, welding as a bonding method is not possible due to the material characteristics of composites. Therefore, although bonding between composites may be performed using an adhesive, such a process causes disadvantages including increased manufacturing costs and poor productivity. Additionally, the use of rivets to couple the composites is limited in that it is difficult to satisfy a required strength of engagement.

The matters disclosed in this section is merely for enhancement of understanding of the general background of the invention and should not be taken as an acknowledgment or any form of suggestion that the matters form the related art already known to a person skilled in the art.

### SUMMARY

Therefore, the present invention provides a connection unit for composites, which enables an upper plate and a lower plate, formed of composites, to be connected by welding.

In accordance with the present invention, a connection unit for composites may connect an upper plate and a lower plate disposed to overlap and formed with apertures vertically penetrating the overlapping portions thereof, the upper plate and the lower plate being formed of composites. In particular, the connection unit may include a first connector having a central first protruding portion and a peripheral first flange portion, the first protruding portion being configured to protrude downward to be inserted into the aperture in the upper plate from the top side thereof, the first protruding portion having a welding recess indented in an upper end thereof, and a second connector having a central second protruding portion and a peripheral second flange portion, the second protruding portion being configured to protrude upward to be inserted into the aperture in the lower plate from the bottom side thereof, the second protruding portion having a welding recess indented in a lower end thereof.

The second protruding portion may have an end that abuts an end of the first protruding portion when the second protruding portion is inserted into the lower plate, wherein the contact ends of the first protruding portion and the second protruding portion may be welded to each other, to secure the upper plate and the lower plate to each other.

The first flange portion and the second flange portion may be configured to apply pressure to an upper surface of the upper plate and a lower surface of the lower plate respectively when the first protruding portion and the second protruding portion are welded to each other. The first flange portion and the second flange portion may respectively form flat surfaces with an upper surface of the upper plate and a lower surface of the lower plate. Additionally, the first flange portion and the second flange portion may respectively extend from an inner circumference of the apertures in the upper plate and the lower plate into the upper plate and the lower plate to be secured thereto. The first protruding portion and the second protruding portion may be welded to each other in a surface-to-surface form and may be subjected to spot welding via the respective welding recesses thereof.

An adhesive may be applied between the upper plate and the lower plate, and the sum of protruding lengths of the first protruding portion and the second protruding portion may be the same as the total depth of the apertures thus allowing the ends of the first protruding portion and the second protruding portion to be in contact with each other within the apertures.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a top view illustrating a connection unit to connect an upper plate and a lower plate according to an exemplary embodiment of the present invention;

FIG. 2 is a side view illustrating the connection unit to connect the upper plate and the lower plate according to the exemplary embodiment of the present invention;

FIG. 3 is a view illustrating a first connector and a second connector according to the exemplary embodiment of the present invention;

FIG. 4 is a view illustrating one exemplary embodiment in which the connection unit of the present invention connects the upper plate and the lower plate to each other;

FIG. 5 is a view illustrating another exemplary embodiment in which the connection unit of the present invention connects the upper plate and the lower plate to each other; and

FIG. 6 is a side view illustrating the connection unit to connect the upper plate and the lower plate according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Reference will now be made in detail to the exemplary embodiments of the present invention, examples of which are illustrated in the accompanying drawings. Wherever possible, the same reference numbers will be used throughout the drawings to refer to the same or like parts.

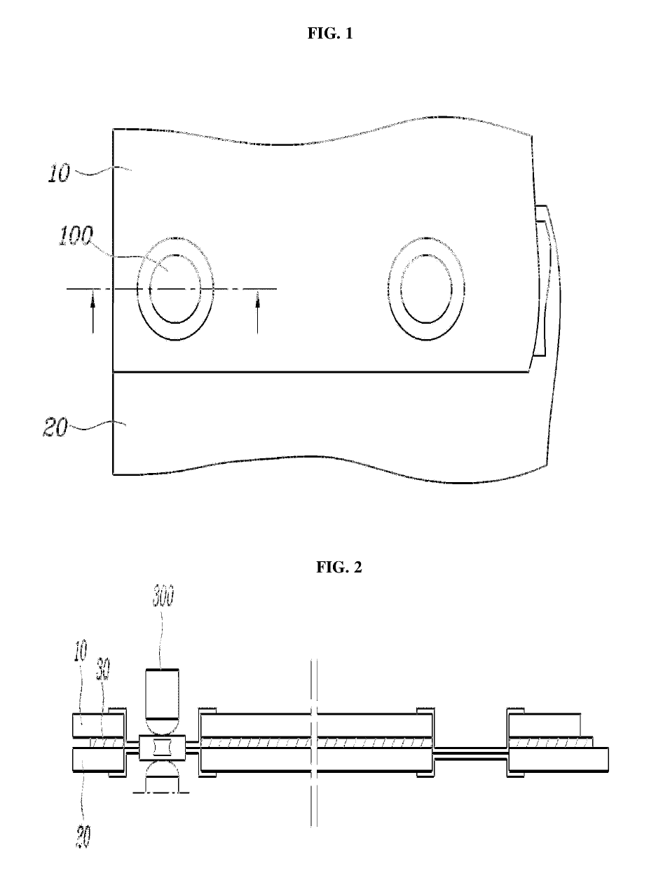

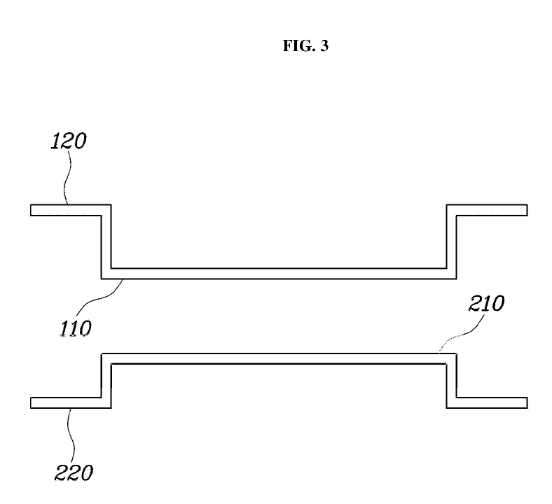

As illustrated in FIG. 1, a connection unit for composites according to the present invention may connect an upper plate 10 and a lower plate 20, arranged to overlap each other and formed with apertures vertically penetrating the overlapping portions thereof, the upper plate 10 and the lower plate 20 being formed of composites. The connection unit may include a first connector 100 and a second connector 200. The first connector 100 may include a central first protruding portion 110 and a peripheral first flange portion 120. The first protruding portion 110 may protrude downward to be inserted into the aperture in the upper plate 10 from the top side thereof. A welding recess may be indented in the upper end of the first protruding portion 110.

Further, the second connector 200 may include a central second protruding portion 210 and a peripheral second flange portion 220. The second protruding portion 210 may protrude upward to be inserted into the aperture in the lower plate 20 from the bottom side thereof. A welding recess may be indented in the lower end of the second protruding portion 210. When the first protruding portion 110 and the second protruding portion 210 have been inserted into the upper plate 10 and the lower plate 20, respectively, the facing ends of the first protruding portion 110 and the second protruding portion 210 are in contact with each other. Accordingly, once the contact ends of the first protruding portion 110 and the second protruding portion 210 are welded to each other, the upper plate 10 and the lower plate 20 may be secured to each other.

When a vehicle body is formed of composites including, e.g. carbon fibers, there is the necessity to bond the composites to each other. Particularly, welding may not be possible due to the material characteristics of the composites. Therefore, although bonding between composites may be performed using an adhesive (30, see FIG. 2), this entails disadvantages including increased manufacturing costs and poor productivity. Moreover, the use of rivets to couple the composites is limited in that it may be difficult to satisfy a required strength of engagement.

According to an exemplary embodiment of the present invention, the upper plate 10 and the lower plate 20, formed of composites, may include the apertures, which may be formed simultaneously in the upper plate 10 and the lower plate 20. In particular, the apertures formed simultaneously in the upper plate 10 and the lower plate 20 may operate as the region at which the upper plate 10 and the lower plate 20 are to be connected. To connect the upper plate 10 and the lower plate 20, the first connector 100 and the second connector 200 are provided. For the first connector 100, the first protruding portion 110 may protrude downward from the center, and the first flange portion 120, which surrounds the first protruding portion 110, may be bent at about a right angle relative to the first protruding portion 110.

The first protruding portion 110 may have the same cross-sectional shape as the aperture. To maintain the stable connection between the first connector 100 and the upper plate 10, the cross-sectional area of the first protruding portion 110 may be equal to or greater than the cross-sectional area of the aperture to allow the first protruding portion 110 of the first connector 100 to be interference-fitted into the upper plate 10. The first flange portion 120 may be bent at about a right angle relative to the first protruding portion 110 as mentioned above, to apply pressure to the upper surface of the upper plate 10 when the first protruding portion 110 is inserted into the aperture in the upper plate 10. Meanwhile, the welding recess may be formed in the upper end of the first protruding portion 110 to a depth that is about the same as the length that the first protruding portion 110 protrudes.

In addition, similar to the first connector 100, in the second connector 200, the second protruding portion 210 may protrude upward from the center, and the second flange portion 220, which surrounds the second protruding portion 210, may be bent at about a right angle relative to the second protruding portion 210. The second protruding portion 210 may have the same cross-sectional shape as the aperture. To maintain the stable connection between the second connector 200 and the lower plate 20, the cross-sectional area of the second protruding portion 210 may be equal to or greater than the cross-sectional area of the aperture to allow the second protruding portion 210 of the second connector 200 to be interference-fitted into the lower plate 20. The second flange portion 220 may be bent at about a right angle from the second protruding portion 210 as mentioned above, to apply pressure to the lower surface of the lower plate 20 when the second protruding portion 210 is inserted into the aperture in the lower plate 20.

Meanwhile, the welding recess may be formed in the lower end of the second protruding portion 210 to a depth that is about the same as the length that the second protruding portion 210 protrudes. The end of the first protruding portion 110 of the first connector 100, inserted into the aperture in the upper plate 10 from the top side, and the end of the second protruding portion 210 of the second connector 200, inserted into the aperture in the lower plate 20 from the bottom side, may be brought into contact with each other within the apertures when the upper plate 10 and the lower plate 20 overlap each other. The first connector 100 and the second connector 200 may be formed of steel and may be coupled to each other by welding the abutting ends of the first protruding portion 110 and the second protruding portion 210, which are in contact with each other within the apertures.

Although the first protruding portion 110 of the first connector 100 and the second protruding portion 210 of the second connector 200 are not limited to protrude at the same length, the sum of the protruding lengths of the first protruding portion 110 and the second protruding portion 210 may be about the same as the total depth of the two apertures in the upper plate 10 and the lower plate 20. In particular, when the first protruding portion 110 and the second protruding portion 210 come into contact with each other (e.g., abut) within the apertures, simultaneously, the first flange portion 120 may be configured to apply pressure to the upper surface of the upper plate 10 and the second flange portion 220 may be configured to apply pressure to the lower surface of the lower plate 20, which maintains the upper plate 10 and the lower plate 20 in the overlapping state.

As described above, by machining or forming the apertures in the upper plate 10 and the lower plate 20 and performing welding on contact portions the first connector 100 and the second connector 200, inserted into the apertures to come into contact with each other within the apertures and formed of steel, the upper plate 10 and the lower plate 20, formed of composites, may be connected without the use of adhesives or rivets.

Since the positions at which the apertures are formed are not limited to the ends of the upper plate 10 and the lower plate 20, which are formed of composites, but may be anywhere that coupling is desired, there is an advantage in that the connection form of the upper plate 10 and the lower plate 20 is not limited. In addition, the connection of the upper plate 10 and the lower plate 20, which are formed of composites, using the welding of the first connector 100 and the second connector 200 as described above may exhibit increased bonding rigidity and durability compared to connection using an adhesive 30. The upper plate 10 and the lower plate 20 may be primarily connected to each other using the adhesive 30, and may be secondarily connected to each other via the welding of the first connector 100 and the second connector 200.

Unlike the case where the upper plate 10 and the lower plate 20, which are formed of composites, are connected to each other using only the adhesive 30, the welding of the first connector 100 and the second connector 200 may advantageously eliminate limitations on connection conditions such as, for example, time and temperature, thus resulting in reduced processing time. In other words, unlike the adhesive 30, the welding of the first connector 100 and the second connector 200 may be implemented in electrostatic coating and painting lines due to robustness against variation in temperature, which may therefore realize a reduction in processing time and contribute to improving productivity.

The connection unit for composites according to the present invention may have a feature wherein the first flange portion 120 and the second flange portion 220 are configured to apply pressure to the upper surface of the upper plate 10 and the lower surface of the lower plate 20 when the first protruding portion 110 and the second protruding portion 210 are welded to each other. When the first protruding portion 110 and the second protruding portion 210 are bonded to each other via welding, the first flange portion 120 may be configured to apply pressure to the upper surface of the upper plate 10 and the second flange portion 220 may be configured to apply pressure to the lower surface of the lower plate 20, and thus the upper plate 10 and the lower plate 20 may receive pressure from the top and the bottom, allowing for the maintenance of the stable connection between maintain the upper plate 10 and the lower plate 20.

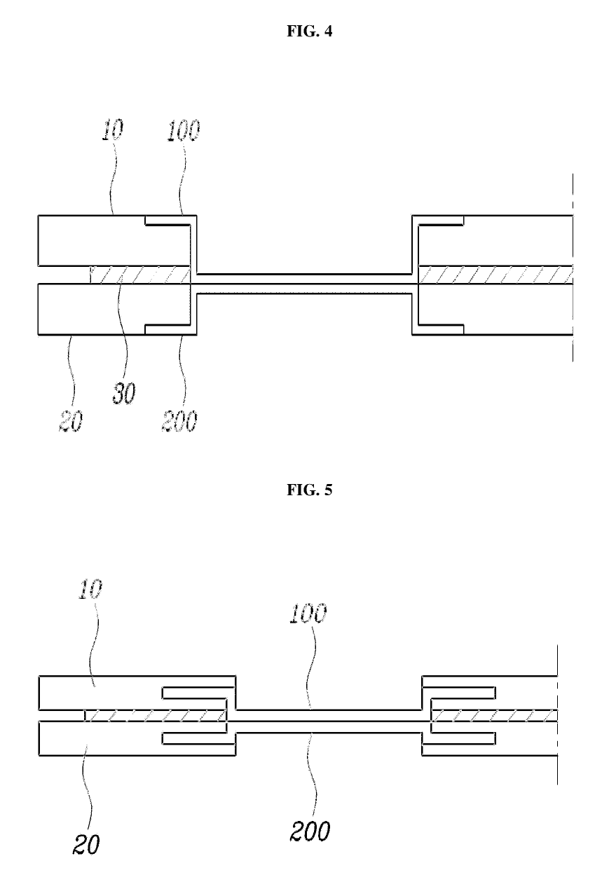

In an exemplary embodiment of the present invention, as illustrated in FIG. 4, the first flange portion 120 and the second flange portion 220 may respectively form flat surfaces with the upper surface of the upper plate 10 and the lower surface of the lower plate 20. The sum of the protruding lengths of the first protruding portion 110 and the second protruding portion 210 may be less than the total depth of the apertures in the upper plate 10 and the lower plate 20. Accordingly, the first flange portion 120 may be configured to apply greater pressure to the upper surface of the upper plate 10 and the second flange portion 220 may be configured to apply greater pressure to the lower surface of the lower plate 20. Accordingly, the first flange portion 120 may form a flat surface with the upper surface of the upper plate 10 and the second flange portion 220 may form a flat surface with the lower surface of the lower plate 20 to thus ensure a stronger continuous connection between the upper plate 10 and the lower plate 20.

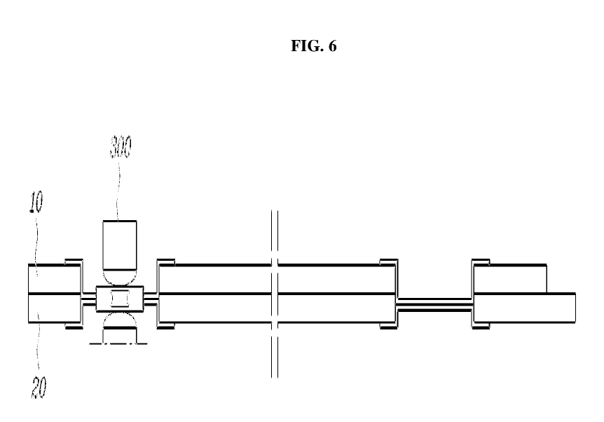

In another exemplary embodiment of the present invention, as illustrated in FIG. 5, the first flange portion 120 and the second flange portion 220 may extend from the inner circumference of the apertures in the upper plate 10 and the lower plate 20 into the upper plate 10 and the lower plate 20 to be secured thereto. Further, in the fabrication of the upper plate 10 and the lower plate 20, which are formed of composites, the first connector 100 may be subjected to insert injection molding when the upper plate 10 is molded and the second connector 200 may be subjected to insert injection molding when the lower plate 20 is molded. With this method, the first flange portion 120 may extend from the inner circumference of the aperture in the upper plate 10 in the direction parallel to the bonding surface of the upper plate 10 and the lower plate 20 to penetrate into the upper plate 10, and the second flange portion 220 may extend from the inner circumference of the aperture in the lower plate 10 in the direction parallel to the bonding surface of the upper plate 10 and the lower plate 20 to penetrate into the lower plate 20.

When the first connector 100 and the second connector 200 are connected to each other in such a manner that the first flange portion 120 and the second flange portion 220 are inserted into the upper plate 10 and the lower plate 20, the first connector 100 and the second connector 200 may advantageously maintain the firm and stable connection between the upper plate 10 and the lower plate 20 without a risk of separation from the upper plate 10 or the lower plate 20. In particular, in the connection unit for composites according to the present invention, the first protruding portion 110 and the second protruding portion 210 may be welded to each other in a surface-to-surface contact form. Welding the first protruding portion 110 and the second protruding portion 210 when in a surface-to-surface contact state may increase the weldable area thus ensuring a stronger connection between the first connector 100 and the second connector 200.

In addition, in the first protruding portion 110 and the second protruding portion 210, spot welding may be implemented through the welding recesses. The respective welding recesses may be disposed opposite the contact region of the first protruding portion 110 and the second protruding portion 210. When electrode rods of a welding apparatus 300, which performs spot welding, are introduced into the welding recesses to apply current, the first connector 100 and the second connector 200 may be secured to each other via welding by resistance heating.

In an exemplary embodiment of the present invention, as illustrated in FIG. 2, the adhesive 30 may be applied between the upper plate 10 and the lower plate 20 to primarily bond the upper plate 10 and the lower plate 20 to each other. Then, the upper plate 10 and the lower plate 20 may be additionally more firmly connected to each other through the use of the connection unit for composites, which includes the first connector 100 and the second connector 200, having contact ends thereof welded to each other. Alternatively, as illustrated in FIG. 6, the upper plate 10 and the lower plate 20 may abut each other without the adhesive 30 disposed therebetween, and may be connected to each other using the connection unit for composites described above.

When both the adhesive 30 and the connection unit for composites are used, the sum of the protruding lengths of the first protruding portion 110 of the first connector 100 and the second protruding portion 210 of the second connector 200 may be determined based on the thickness of the adhesive 30, rather than being set the same as the total depth of the apertures in the upper plate 10 and the lower plate 20. By setting the sum of the protruding lengths of the first protruding portion 110 and the second protruding portion 210 of the connection unit for composites to a greater value as described above, the top and bottom positions of the connection unit may be adjusted, as from the left side of FIG. 2.

Meanwhile, by configuring the second connector 200 of the connection unit for composites to be inserted into the lower plate 20, as seen from the right side of FIG. 2, the left and right positions of the connection unit may be adjusted. In particular, when both the adhesive 30 and the connection unit for composites are used, the first connector 100 and the second connector 200 may be utilized, based on the shapes thereof, as guides to adjust the top and bottom positions and the left and right positions. In addition, the first connector 100 and the second connector 200 may also be utilized as spacers. In addition, when the connection unit for composites is used alone, the sum of the protruding lengths of the first protruding portion 110 of the first connector 100 and the second protruding portion 210 of the second connector 200 may be the same as the total depth of the apertures in the upper plate 10 and the lower plate 20 as mentioned above, whereby the first flange portion 120 may be configured to apply pressure to the upper surface of the upper plate 10 and the second flange portion 220 may be configured to apply pressure to the lower surface of the lower plate 20.

Further, both the adhesive 30 and the connection unit for composites may be used at selected regions where a particularly strong connection is required, and the connection unit for composites may be used alone at other regions. In other words, the adhesive 30 may be added to merely particular regions while the connection unit is used for all regions. Such a configuration may prevent an increase in manufacturing costs caused by excessive use of the adhesive 30 while maintaining the strong connection state.

As is apparent from the above description, according to a connection unit for composites of the present invention, the positions at which apertures are formed are not limited to the ends of an upper plate and a lower plate, but may be anywhere that coupling is desired. As a result, the present invention has an advantage in that the connection form of the upper plate and the lower plate is not limited.

In addition, the present invention has the effect of increasing bonding rigidity and durability compared to connecting using adhesives. Unlike connection using adhesives, connecting using the connection unit of the present invention may advantageously eliminate limitations on connection conditions such as, for example, time and temperature, thus resulting in reduced processing time. In other words, unlike connection using adhesives, welding connection may be implemented in electrostatic coating and painting lines due to robustness against variation in temperature, which may therefore realize a reduction in processing time and contribute to improving productivity.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A connection unit for composites, which is configured to connect an upper plate and a lower plate that overlap each other and are each formed with an aperture vertically penetrating the overlapping portions thereof, the upper plate and the lower plate being formed of composites, the connection unit comprising:
a first connector including a central first protruding portion and a peripheral first flange portion, the first protruding portion being configured to protrude downward to be inserted into the aperture in the upper plate from the top side thereof, the first protruding portion having a welding recess indented in an upper end thereof; and
a second connector including a central second protruding portion and a peripheral second flange portion, the second protruding portion being configured to protrude upward to be inserted into the aperture in the lower plate from the bottom side thereof, the second protruding portion having a welding recess indented in a lower end thereof, the second protruding portion having an end configured to come into contact with an end of the first protruding portion when the second protruding portion is inserted into the lower plate,
wherein the contact ends of the first protruding portion and the second protruding portion are welded to each other to secure the upper plate and the lower plate to each other.

2. The connection unit for composites according to claim 1, wherein the first flange portion and the second flange portion are configured to apply pressure to an upper surface of the upper plate and a lower surface of the lower plate respectively when the first protruding portion and the second protruding portion are welded to each other.

3. The connection unit for composites according to claim 1, wherein the first flange portion and the second flange portion respectively form flat surfaces with an upper surface of the upper plate and a lower surface of the lower plate.

4. The connection unit for composites according to claim 1, wherein the first flange portion and the second flange portion respectively extend from an inner circumference of the apertures in the upper plate and the lower plate into the upper plate and the lower plate to be secured thereto.

5. The connection unit for composites according to claim 1, wherein the first protruding portion and the second protruding portion are welded to each other in a surface-to-surface form.

6. The connection unit for composites according to claim 1, wherein the first protruding portion and the second protruding portion are subjected to spot welding via the respective welding recesses thereof.

7. The connection unit for composites according to claim 1, wherein an adhesive is applied between the upper plate and the lower plate, and the sum of protruding lengths of the first protruding portion and the second protruding portion is the same as the total depth of the apertures to cause the ends of the first protruding portion and the second protruding portion to be in contact with each other within the apertures.

8. The connection unit for composites according to claim 1, an adhesive is applied at a particular region between the upper plate and the lower plate, and the sum of protruding lengths of the first protruding portion and the second protruding portion is determined based on a thickness of the adhesive.
